(19) United States
(12) Patent Application Publication
(10) Pub. No.: US 2012/0278739 A1
(43) Pub. Date: Nov. 1, 2012

(54) SYSTEM AND METHOD OF TRIGGERING PERIODIC EVENTS WITHIN AN INSTANCE OF A VIRTUAL SPACE

(75) Inventor: Tim McClarren, San Francisco, CA (US)

(73) Assignee: Idle Games, San Francisco, CA (US)

(21) Appl. No.: 13/094,380

(22) Filed: Apr. 26, 2011

(51) Int. Cl. G06F 3/048

(52) U.S. Cl. 715/757

(57) ABSTRACT

A virtual space is provided to users via client computing devices. In order to execute an instance of the virtual space, periodic events within the instance of the virtual space may be triggered with the appropriate periodicities. The periodic triggering may be implemented without the need to remove and/or re-enter an event after each trigger.

### FIELD OF THE INVENTION

The invention relates to triggering periodic events in an instance of a virtual space without updating a list of actions to be performed when a periodic event is triggered.

### BACKGROUND OF THE INVENTION

Systems that execute instances of virtual spaces are known. Some instances of virtual spaces include periodic events that may be triggered at regular intervals. Such events include, for example, regenerative events, degenerative events, regular or cyclical non-player character actions, cyclical ambient events (e.g., day/night, seasons, and/or other cyclical ambient events).

In conventional virtual space systems, the processing cost of such events may be relatively high. This may be a function of maintaining an event list of tasks to be completed and the times at which they should be initiated. At the appropriate time, a periodic event may be initiated. To maintain the periodicity of the event, the event may then be removed from the list, and added to the list at a future time dictated by the event's period. As the size of an instance of a virtual space, and/or the number of periodic events therein, increases, maintaining the ongoing initiation of periodic events may be a significant processing cost for a server.

### SUMMARY

One aspect of the invention relates to a system and method of hosting an instance of a virtual space to client computing devices for interaction by users. In order to execute an instance of the virtual space, periodic events may be triggered with the appropriate periodicities. The periodic triggering may be implemented without the need to remove and/or re-enter an event after each trigger.

In some implementations, an instance of the virtual space may be executed by a server that hosts the virtual space for the client computing devices. The server may be configured to execute computer program modules including, for example, a space module, a time module, an event grouping module, a timeline module, a timeslot translation module, an event trigger module, and/or other modules.

The space module may be configured to implement the instance of the virtual space to determine views of the virtual space for presentation to the users on the client computing devices. The views (and/or information representing the views) may be transmitted to the client computing devices. The space module may be configured to receive input from the users entered at the client computing devices. The received input may be used to enable the user to interact with the virtual space and/or other users in the virtual space by performing actions in the virtual space based on the received input.

The time module may be configured to maintain a time reading in the instance of the virtual space. The time reading may be the time standard in the instance of the virtual space. The time reading may be a conventional date/time reading that increments in seconds, minutes, and/or other regular intervals, a numerical count of time increments from an initial time, and/or other time readings. Maintaining the time reading may include incrementing the time reading at regular intervals.

The event grouping module may be configured to group periodic events in the virtual space into sets based on the periods of the periodic events. The sets may be formed to include periodic events having corresponding periods. The corresponding periods of the events in a given set may be periods of a common length, periods that are an integer product of a base length, and/or periods that otherwise correspond. The event grouping module may be configured such that individual sets of periodic events may include events of a common event type, or of periodic events of different types but corresponding periods.

The timeline module may be configured to organize periodic events into recursive timelines by assigning the periodic events to timeslots in timelines having lengths that correspond to the periods of the periodic events. This may include organizing the periodic events grouped into a given set of events into the timeslots of a common timeline. The length of the timeline may correspond to the period(s) of the events in the given set of events.

The timeslot translation module may be configured to translate the time reading maintained by the time module into the timeslots of the recursive timelines. For example, as the time reading is incremented the timeslot translation module may be configured to iteratively translate the time reading into a next timeslot in a given timeline from an initial timeslot in the given timeline, through the timeslots in the given timeline, to a final timeslot in the given timeline, and then back to the initial timeslot. This may result in the timeslot translation module looping through the timeslots of the timelines in an ongoing manner.

The event trigger module may be configured to trigger the periodic events at the assigned timeslots in the timelines. As the timeslot translation module translates the time reading into the timeslots of the timelines, the event trigger module may cycle recursively through the timelines triggering the periodic events in the timelines with the periodicities dictated by the length of the timelines. As such, the individual periodic events may be triggered with appropriate periodicity.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide a virtual space to users.

FIG. 2 illustrates a timeline with timeslots.

FIG. 3 illustrates a timeline with timeslots.

FIG. 4 illustrates a method of providing a virtual space to users.

### DETAILED DESCRIPTION

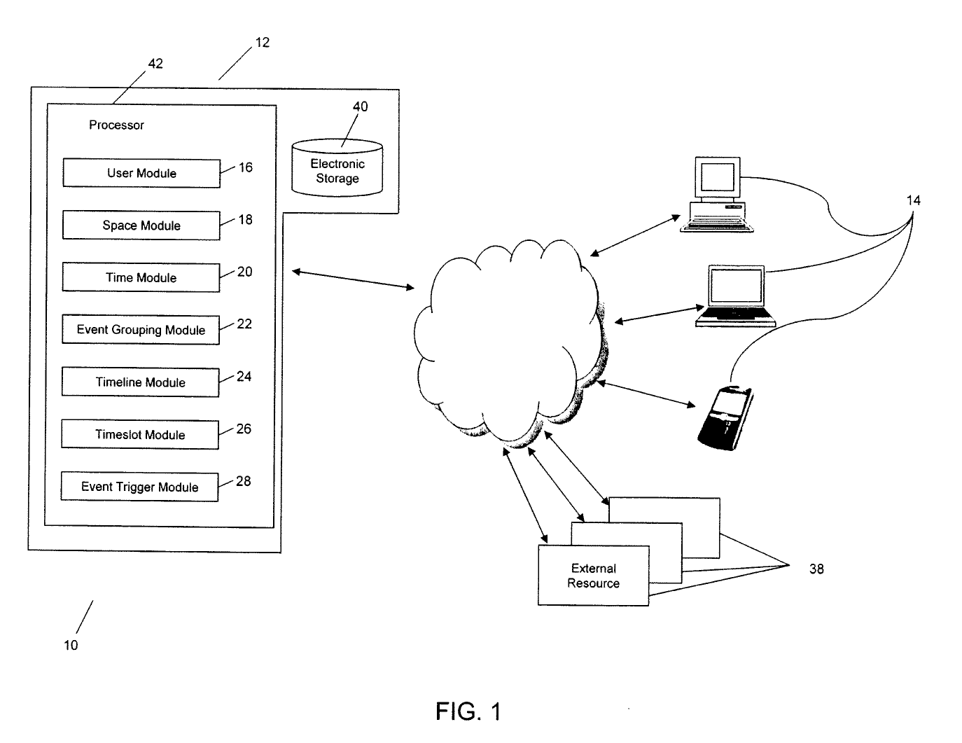

FIG. 1 illustrates a system 10 configured to provide a virtual space to users. The virtual space may be a space in which a game is played, in which users communicate with each other, and/or in which other activities are conducted. Providing the virtual space may include hosting the virtual space over a network. In some implementations, system 10 may include a server 12. The server 12 may be configured to communicate with one or more client computing platforms 14 according to a client/server architecture. The users may access system 10 and/or the virtual space via client computing platforms 14.

The server 12 may be configured to execute one or more computer program modules. The computer programs may be configured to execute one or more instances of a virtual space. The computer program modules may include one or more of a user module 16, a space module 18, a time module 20, an event grouping module 22, timeline module 24, a timeslot module 26, an event trigger module 28, and/or other modules.

The user module 16 may be configured to access and/or manage one or more user profiles and/or user information associated with users of the system 10. The one or more user profiles and/or user information may include information stored by server 12, one or more of the client computing platforms 14, and/or other storage locations. The user profiles may include, for example, information identifying users (e.g., a username or handle, a number, an identifier, and/or other identifying information) within the virtual space, security login information (e.g., a login code or password), virtual space account information, subscription information, virtual currency account information (e.g., related to currency held in credit for a user), relationship information (e.g., information related to relationships between users in the virtual space), virtual space usage information, demographic information associated with users, interaction history among users in the virtual space, information stated by users, purchase information of users, browsing history of users, a client computing platform identification associated with a user, a phone number associated with a user, and/or other information related to users.

The space module 18 may be configured to implement the instance of the virtual space executed by the computer modules to determine views of the virtual space. The views may then be communicated (e.g., via streaming, via object/position data, and/or other information) from server 12 to client computing platforms 14 for presentation to users. The view determined and transmitted to a given client computing platform 14 may correspond to a user character being controlled by a user via the given client computing platform 14. The view determined and transmitted to a given client computing platform 14 may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user.

The instance of the virtual space may comprise a simulated space that is accessible by users via clients (e.g., client computing platforms 14) that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the destination node, and/or surface features of a surface or objects that are “native” to the destination node. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the computer modules may be synchronous, asynchronous, and/or semi-synchronous.

The above description of the manner in which views of a space are determined by space module 18 is not intended to be limiting. The space module 18 may be configured to express the virtual space in a more limited, or more rich, manner. For example, views determined for the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the virtual space, space module 18 may be configured to execute events in instance of the virtual space. These events may include user-triggered events, random events, reactive events, periodic events, and/or other events. User-triggered events may include events within the virtual space that are triggered by user input or control received to server 12 via client computing platforms 14. Random events may include event that are triggered randomly within the instance of the virtual space. The times these are to be triggered may be determined based on output from a random number generator and/or through other random, pseudo-random, or seemingly random mechanisms. Reactive events may include events in the instance that are triggered by the occurrence of one or more other events. Periodic events may include events that have a regular period or frequency.

Within the instance of the virtual space executed by the computer program modules, users may control characters, objects, simulated physical phenomena (e.g., wind, rain, earthquakes, and/or other phenomena), and/or other elements within the space to interact with the space and/or each other. The user characters may include avatars. As used herein, the term “user character” may refer to an object (or group of objects) present in the virtual space that represents an individual user. The user character may be controlled by the user with which it is associated. The user controlled element(s) may move through and interact with the virtual space (e.g., non-user characters in the virtual space, other objects in the virtual space). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual space.

The users may participate in the instance of the virtual space by controlling one or more of the available user controlled elements in the space. Control may be exercised through control inputs and/or commands input by the users through client computing platforms 14. The users may interact with each other through communications exchanged within the virtual space. Such communications may include one or more of textual chat, instant messages, private messages, voice communications, and/or other communications. Communications may be received and entered by the users via their respective client computing platforms 14. Communications may be routed to and from the appropriate users through server 12 (e.g., through space module 18).

The time module 20 may be configured to keep time for the instance of the virtual space. This may include maintaining a time reading for the instance. The time reading may be a conventional date/time reading that increments in seconds, minutes, and/or other regular intervals, a numerical count of time increments from an initial time, and/or other time readings. The time module 20 may maintain the time reading by incrementing the time reading at regular intervals. This may include, for example, incrementing the time reading in time with a clock signal that denotes the passing of seconds, minutes, and/or other time intervals.

As was mentioned above with respect to space module 18, events that occur within the instance of the virtual space include periodic events with regular periodicity in the instance. Such events may include regenerative events, such as incremental resource, character, or plant growth or development, character power or skill recharging, and/or other regenerative events. Periodic events may include repetitive events such as non-player character movements or actions that are repetitive, cyclical ambient events (e.g., day/night, seasonal changes, and/or other ambient events), and/or other events. Other types of periodic events may exist in the instance.

The event grouping module 22 may be configured to group periodic events in the instance of the virtual space into sets. The sets may be formed to include periodic events having corresponding periods. The corresponding periods of the events in a given set may be periods of a common length, periods that are an integer product of a base length, and/or periods that otherwise correspond. The sets may be formed by event grouping module 22 such that the periods in a given set are of a common event-type. For example, if a given type of plant in the instance grows or develops at a set rate, a periodic growth event may exist for each of the plants of the given type in the instance. The event grouping module 22 may organize the periodic growth event for the plants of the given type into a single set. The single set may include only these periodic growth events, or the single set may include other types of periodic events with corresponding periods.

The timeline module 24 may be configured to organize periodic events into recursive timelines. The timelines may include timeslots. Organizing the periodic events into timelines may include assigning individual sets of periodic events to individual timelines. The sets of periodic events may be assigned to timelines having lengths that correspond to the periods of the periodic events. The individual events within a given set may then be placed into timeslots of the timeline to which the given set of periodic events has been assigned.

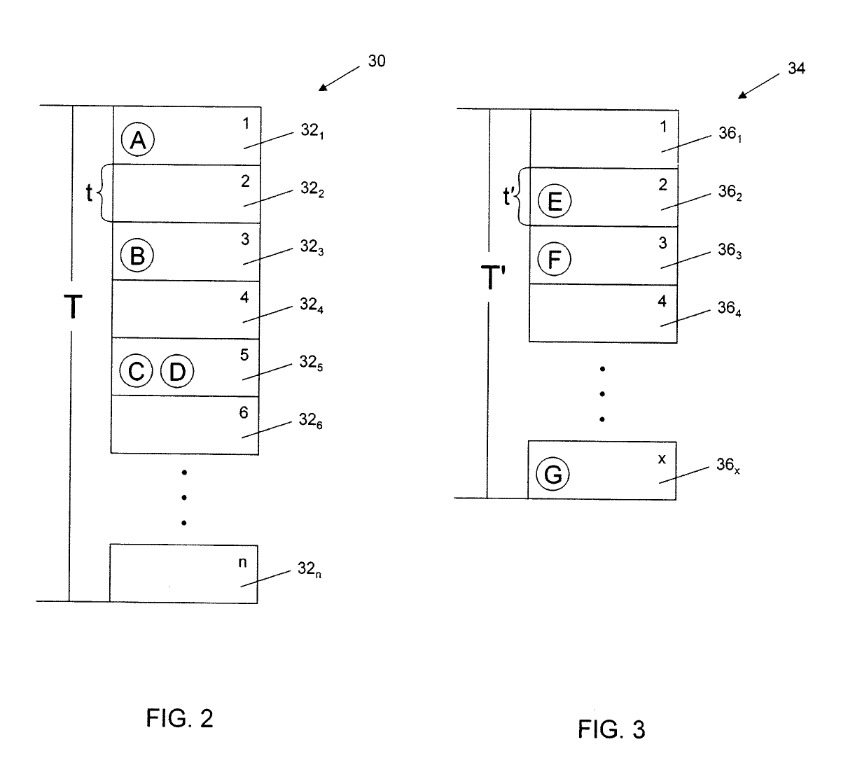

By way of illustration FIG. 2 depicts a schematic representation of a timeline 30 and a set of periodic events. The timeline may have a length of time T that corresponds to the period(s) of the events A-D in the first set of periodic events. The timeline 30 may include n timeslots 32 (illustrated in FIG. 2 as timeslots 32₁, 32₂, 32₃, 32₄, 32₅, 32₆, and 32ₙ). The timeslots 32 may individually correspond to a common increment of time t. The common increment of time may correspond to the interval of time at which the time reading is incremented by time module 20 (e.g., an integer product of the interval of time). The timeslots 32 may include an initial timeslot 32₁ and an n^{th} timeslot 32ₙ. During execution of the instance of the virtual space, the set of periodic events may not be closed. One or more new periodic events may be added to the set of periodic events, and/or one or more of periodic events 32₁-32ₙ may be dropped. The set of periodic events includes an event A, an event B, an event C, and an event D.

The organization of the set of periodic events into timeline 30 may include assigning individual ones of events A-D to an appropriate one of timeslots 32₁-32ₙ. In the non-limiting example illustrated in FIG. 2, event A may be assigned to the initial timeslot 32₁, event B may be assigned to timeslot 32₃, and events C and D may be assigned to timeslot 32₅.

Referring back to FIG. 1, timeslot module 26 may be configured to translate the time reading maintained by time module 20 into the timeslots of the recursive timelines. This may include translating the time reading into a next timeslot in a given timeline when the time reading indicates that an increment of time corresponding to a current timeslot has passed since the current timeslot began. This may be performed until a final timeslot in the given timeline is reached. Then, responsive to the time reading indicating that an increment of time corresponding to the final timeslot has been reached, timeslot module 26 may be configured to return back to an initial timeslot in the timeline.

By way of illustration, turning back to FIG. 2, at an initial time reading, initial timeslot 32₁ may begin. Responsive to the time reading indicating that the amount of time t has passed, the time reading may be translated into timeslot 32₂. As the time reading is successively translated through timeslots 32₁-32ₙ, after length of time T has passed (at which time the time reading may be translated into the n^{th} timeslot 32ₙ), the time reading may be translated back into initial timeslot 32₁. This may result in recursive iteration through the timeslots 32 of timeline 30.

Referring back to FIG. 1, event trigger module 28 may be configured to cycle through the timelines as the time reading maintained by time module 20 is incremented, and to trigger the periodic events in the timelines at the periodicities dictated by the length of the timelines. This may include triggering the periodic events at the assigned timeslots in the timelines.

By way of illustration, reference back to FIG. 2 is made. Responsive to the time reading being translated into initial timeslot 32₁, event A may be triggered. Similarly, as translated from the initial timeslot 32₁ to the n^{th} timeslot 32ₙ, and back to the initial timeslot 32₁, and so on, event b may be triggered responsive to the time reading being translated into timeslot 32₃. Responsive to the time reading being translated into timeslot 32₅, events C and D may be triggered.

FIG. 3 illustrates a timeline 34 having a different length T′ than the length T of timeline 32 (shown in FIG. 2 and described herein). The length of time T′ may, for example, be shorter than length of time T (shown in FIG. 2). The timeline 34 may include x timeslots 36₁-36ₓ. Timeslots 36₁-36ₓ may correspond to a common increment of time t′. The increment of time t′ may be less than the increment of time t (shown in FIG. 2), more than the increment of time t, or the same as the increment of time t. A second set of events, including events E-G may be assigned to timeline 34. The period(s) events E-G may correspond to length of time T′. By way of non-limiting example, event E may be assigned to timeslot 36₂, event F may be assigned to timeslot 36₃, and/or event G may be assigned to timeslot 36ₓ. The periodicities of events A-G in FIGS. 2 and 3 is obtained without having to remove and/or re-enter individual events or sets of events at each period.

As an event trigger module similar to or the same as event trigger module 28 (e.g., shown in FIG. 1 and described herein) cycles through timelines 30 and 34 of FIGS. 2 and 3, respectively, the events A-D in timeline 30 may be triggered at different periods than events E-G in timeline 34. Specifically, events A-D may be triggered with the period T and events E-G may be triggered the period T′.

Returning to FIG. 1, the server 12, client computing platforms 14, and/or external resources 44 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, client computing platforms 14, and/or external resources 38 may be operatively linked via some other communication media.

A given client computing platform 14 may include one or more processors configured to execute computer program modules. The computer program modules may be configured to enable an expert or user associated with the given client computing platform 14 to interface with system 10 and/or external resources 44, and/or provide other functionality attributed herein to client computing platforms 14. By way of non-limiting example, the given client computing platform 14 may include one or more of a desktop computer, a laptop computer, a handheld computer, a NetBook, a Smartphone, a gaming console, and/or other computing platforms.

The external resources 38 may include sources of information, hosts and/or providers of virtual environments outside of system 10, external entities participating with system 10, and/or other resources. In some implementations, some or all of the functionality attributed herein to external resources 38 may be provided by resources included in system 10.

The server 12 may include electronic storage 40, one or more processors 42, and/or other components. The server 12 may include communication lines, or ports to enable the exchange of information with a network and/or other computing platforms. Illustration of server 12 in FIG. 1 is not intended to be limiting. The server 12 may include a plurality of hardware, software, and/or firmware components operating together to provide the functionality attributed herein to server 12. For example, server 12 may be implemented by a cloud of computing platforms operating together as server 12.

Electronic storage 40 may comprise electronic storage media that electronically stores information. The electronic storage media of electronic storage 40 may include one or both of system storage that is provided integrally (i.e., substantially non-removable) with server 12 and/or removable storage that is removably connectable to server 12 via, for example, a port (e.g., a USB port, a firewire port, etc.) or a drive (e.g., a disk drive, etc.). Electronic storage 40 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 40 may include one or more virtual storage resources (e.g., cloud storage, a virtual private network, and/or other virtual storage resources). Electronic storage 40 may store software algorithms, information determined by processor 42, information received from server 12, information received from client computing platforms 14, and/or other information that enables server 12 to function properly.

Processor(s) 42 is configured to provide information processing capabilities in server 12. As such, processor 42 may include one or more of a digital processor, an analog processor, a digital circuit designed to process information, an analog circuit designed to process information, a state machine, and/or other mechanisms for electronically processing information. Although processor 42 is shown in FIG. 1 as a single entity, this is for illustrative purposes only. In some implementations, processor 42 may include a plurality of processing units. These processing units may be physically located within the same device, or processor 42 may represent processing functionality of a plurality of devices operating in coordination. The processor 42 may be configured to execute modules 16, 18, 20, 22, 24, 26, and/or 28. Processor 42 may be configured to execute modules 16, 18, 20, 22, 24, 26, and/or 28 by software; hardware; firmware; some combination of software, hardware, and/or firmware; and/or other mechanisms for configuring processing capabilities on processor 48.

It should be appreciated that although modules 16, 18, 20, 22, 24, 26, and/or 28 are illustrated in FIG. 1 as being co-located within a single processing unit, in implementations in which processor 48 includes multiple processing units, one or more of modules 16, 18, 20, 22, 24, 26, and/or 28 may be located remotely from the other modules. The description of the functionality provided by the different modules 16, 18, 20, 22, 24, 26, and/or 28 described below is for illustrative purposes, and is not intended to be limiting, as any of modules 16, 18, 20, 22, 24, 26, and/or 28 may provide more or less functionality than is described. For example, one or more of modules 16, 18, 20, 22, 24, 26, and/or 28 may be eliminated, and some or all of its functionality may be provided by other ones of modules 16, 18, 20, 22, 24, 26, and/or 28. As another example, processor 42 may be configured to execute one or more additional modules that may perform some or all of the functionality attributed below to one of modules 16, 18, 20, 22, 24, 26, and/or 28.

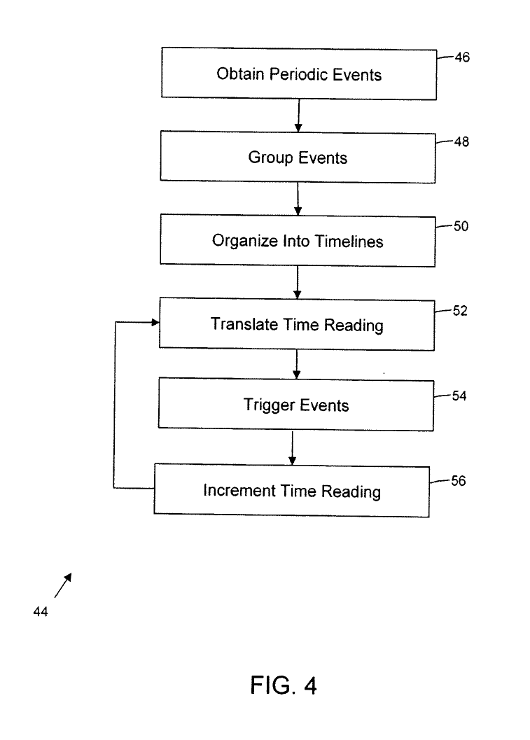

FIG. 4 illustrates a method 44 of hosting a virtual space to client computing devices for interaction by users. The operations of method 44 presented below are intended to be illustrative. In some embodiments, method 44 may be accomplished with one or more additional operations not described, and/or without one or more of the operations discussed. Additionally, the order in which the operations of method 44 are illustrated in FIG. 4 and described below is not intended to be limiting.

In some embodiments, method 44 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 44 in response to instructions stored electronically on an electronic storage medium. The one or more processing devices may include one or more devices configured through hardware, firmware, and/or software to be specifically designed for execution of one or more of the operations of method 44.

At an operation 46, periodic events in the virtual space may be obtained. The periodic events may include events in the virtual space that are to be triggered with previously specified periods. In some implementations, operation 46 may be performed by an event grouping module similar to or the same as event grouping module 22 (shown in FIG. 1 and described above).

At an operation 48, the periodic events may be grouped into sets of periodic events. The periodic events may be grouped based on the length of periodicity. For example, a given set of periodic events may be made up of events having a common period, having periods that are an integer product of some base period, and/or have other commonalities in period. In some implementations, operation 48 may be performed by an event grouping module 22 similar to or the same as event grouping module 22 (shown in FIG. 1 and described above).

At an operation 50, the periodic events may be organized into recursive timelines. This may include assigning individual events in the periodic events to timeslots in the timelines. For example, the events from a given set of events may be assigned to the timeslots of a common timeline. The timelines may have lengths that correspond to the periods of the periodic events. In some implementations, operation 50 may be performed by a timeline module similar to or the same as timeline module 24 (shown in FIG. 1 and described above).

It will be appreciated that the positioning of operations 46, 48, and/or 50 as discrete operations at the front of method 44 is not intended to be limited. To some extent, operations 46, 48, and/or 50 may include ongoing aspects as new periodic events are added to the instance of the virtual space, and/or as periodic events are removed from the instance of the virtual space, among other phenomena which may result in re-collection and/or re-organization of periodic events.

At an operation 52, a time reading may be translated into the timeslots of the timelines. The time reading may mark the passage of time within the instance of the virtual space. The translation may be ongoing such that as the time reading is incremented the time reading may be iteratively translated into a next timeslot in a given timeline from an initial timeslot, through the timeslots in the given timeline, to a final timeslot, and then back to the initial timeslot. In some implementations, operation 52 may be performed by a timeslot module similar to or the same as timeslot module 26 (shown in FIG. 1 and described above).

At an operation 54, the periodic events may be triggered. This may include triggering the periodic events that have been assigned to current timeslots in the timelines. In some implementations, operation 56 may be performed by an event trigger module similar to or the same as event trigger module 28 (shown in FIG. 1 and described above).

At an operation 56, the time reading may be incremented. This may maintain the time reading in the instance of the virtual space. In some implementations, operation 56 may be performed by a time module similar to or the same as time module 20 (shown in FIG. 1 and described above).

Method 44 may loop back over operations 52, 54, and 56. This may accomplish the ongoing and periodic nature of the periodic events.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to host a virtual space to client computing devices for interaction by users of the client computing devices, the system comprising:
one or more processors configured to execute computer program modules configured to instance a virtual space, the computer program modules comprising:
a time module configured to maintain a time reading in the instance of the virtual space by incrementing the time reading at regular intervals;
a timeline module configured to organize periodic events into recursive timelines, the periodic events comprising a first set of periodic events having a first period, wherein the timeline module is configured such that the first set of periodic events is organized by assigning individual events in the first set of periodic events to timeslots in a first timeline associated with the first set of periodic events, wherein the first timeline has n timeslots and has a length that corresponds to the first period;
a timeslot translation module configured to translate the time reading maintained by the time module into the timeslots of the recursive timelines such that as the time reading is incremented the time reading is iteratively translated into a next timeslot in the first timeline from an initial timeslot in the first timeline through the timeslots in the first timeline to an n^{th} timeslot in the first timeline and back to the initial timeslot;
an event trigger module configured to trigger the periodic events at the assigned timeslots in the timelines, thereby causing the individual periodic events to be triggered with appropriate periodicity, wherein the event trigger module is configured such that responsive to the time reading being incremented to a value translated by the timeslot translation module as an m^{th} timeslot between the initial timeslot in the first timeline and the n^{th} timeslot in the first timeline, the event trigger module triggers, in the instance of the virtual space, the periodic events in the first set of periodic events assigned to the m^{th} timeslot in the first timeline.

2. The system of claim 1, wherein the computer modules further comprise a space module configured to implement the instance of the virtual space to determine views of the virtual space for presentation to a user on a client computing devices, and to enable the user to interact with the virtual space and/or other users in the virtual space by performing actions in the virtual space based on input of the user received from the client computing platform.

3. The system of claim 1, wherein the computer program modules further comprise an event grouping module configured to group periodic events in the virtual space into sets based on the periods of the periodic events.

4. The system of claim 1, wherein the first set of periodic events is made up of periodic events having a common event-type.

5. The system of claim 1, wherein the first set of periodic events includes periodic events having different event-types but a common period.

6. The system of claim 1, wherein the periodic events comprise a second set of periodic events having a second period that is different from the first period,
wherein the timeline module is configured such that the second set of periodic events is organized by assigning individual events in the second set of periodic events to timeslots in a second timeline associated with the second set of periodic events, wherein the second timeline has x timeslots and a length that corresponds to the second period,
wherein the timeslot translation module is configured such that as the time reading is incremented the time reading is iteratively translated into a next timeslot in the second timeline from an initial timeslot in the second timeline through the timeslots in the second timeline to an x^{th} timeslot in the second timeline, and
wherein the event trigger module is configured such that responsive to the time reading being incremented to a value translated by the timeslot translation module as an z^{th} timeslot between the initial timeslot in the second timeline and the x^{th} timeslot in the second timeline, the event trigger module triggers, in the instance of the virtual space, the periodic events in the second set of periodic events assigned to the z^{th} timeslot in the second timeline.

7. A method of hosting a virtual space to client computing devices for interaction by users of the client computing devices, the method comprising:
maintaining a time reading in the instance of the virtual space by incrementing the time reading at regular intervals;
organizing periodic events into recursive timelines, the periodic events comprising a first set of periodic events having a first period, wherein the first set of periodic events are organized by assigning individual events in the first set of periodic events to timeslots in a first timeline associated with the first set of periodic events, wherein the first timeline has n timeslots and has a length that corresponds to the first period;
translating, in an ongoing manner, the time reading into the timeslots of the recursive timelines such that as the time reading is incremented the time reading is iteratively translated into a next timeslot in the first timeline from an initial timeslot in the first timeline through the timeslots in the first timeline to an n^{th} timeslot in the first timeline and back to the initial timeslot; and
triggering the periodic events at the assigned timeslots in the timelines, thereby causing the individual periodic events to be triggered with appropriate periodicity, wherein, responsive to the time reading being incremented to a value translated as an m^{th} timeslot between the initial timeslot in the first timeline and the n^{th} timeslot in the first timeline, the periodic events in the first set of periodic events assigned to the m^{th} timeslot in the first timeline are triggered in the instance of the virtual space.

8. The method of claim 7, further comprising implementing the instance of the virtual space to determine views of the virtual space for presentation to a user on a client computing devices, and to enable the user to interact with the virtual space and/or other users in the virtual space by performing actions in the virtual space based on input of the user received from the client computing platform.

9. The method of claim 7, further comprising grouping periodic events in the virtual space into sets based on the periods of the periodic events.

10. The method of claim 7, wherein the first set of periodic events is made up of periodic events having a common event-type.

11. The method of claim 7, wherein the first set of periodic events includes periodic events having different event-types but a common period.

12. The method of claim 7, wherein the periodic events comprise a second set of periodic events having a second period that is different from the first period,
wherein organizing the periodic events further comprises organizing the second set of periodic events by assigning individual events in the second set of periodic events to timeslots in a second timeline associated with the second set of periodic events, wherein the second timeline has x timeslots and a length that corresponds to the second period,
wherein translating the time reading comprises iteratively translating the time reading into a next timeslot in the second timeline from an initial timeslot in the second timeline through the timeslots in the second timeline to an x^{th} timeslot in the second timeline, and
wherein triggering the periodic events comprises, responsive to the time reading being incremented to a value translated as an z^{th} timeslot between the initial timeslot in the second timeline and the x^{th} timeslot in the second timeline, triggering the periodic events in the second set of periodic events assigned to the z^{th} timeslot in the second timeline within the instance of the virtual space.

13. A system configured to host a virtual space to client computing devices for interaction by users of the client computing devices, the system comprising:
one or more processors configured to execute computer program modules configured to instance the virtual space, the computer program modules comprising:
a time module configured to maintain a time reading in the instance of the virtual space by incrementing the time reading at regular intervals;
a timeline module configured to organize periodic events into recursive timelines by assigning the periodic events to timeslots in timelines having lengths that correspond to the periods of the periodic events;
an event trigger module configured to cycle recursively through the timelines as the time reading is incremented, and to trigger the periodic events in the timelines with the periodicities dictated by the length of the recursive timelines.

14. The system of claim 13, wherein the timeline module and the event trigger module are configured such that the timelines are cycled through recursively to periodically trigger the periodic events without requiring alteration or adjustment of the timelines or the periodic events assigned thereto.

15. The system of claim 13, wherein the computer modules further comprise a space module configured to implement the instance of the virtual space to determine views of the virtual space for presentation to a user on a client computing devices, and to enable the user to interact with the virtual space and/or other users in the virtual space by performing actions in the virtual space based on input of the user received from the client computing platform.

16. The system of claim 13, wherein the computer program modules further comprise an event grouping module configured to group periodic events in the virtual space into sets based on the periods of the periodic events, wherein the timeline module is further configured to assign periodic events in a common set to timeslots in a common timeline.

17. The system of claim 16, wherein the event grouping module is configured such that individual sets of periodic events are made up of periodic events having common event-types.

18. The system of claim 16, wherein the event grouping module is configured such that individual sets of periodic events are made up of periodic events having different event-types but common periods.
